(19) United States
(12) Patent Application Publication
(10) Pub. No.: US 2025/0011558 A1
(43) Pub. Date: Jan. 9, 2025

(54) METHOD FOR REDUCING SURFACE TENSION OF POLYMER MATERIAL AND METHOD FOR CONTROLLING ORIENTATION OF BLOCK COPOLYMER THIN FILM BY DECOMPRESSION EFFECT

(71) Applicant: NATIONAL TSING HUA UNIVERSITY, Hsinchu (TW)

(72) Inventors: Rong-Ming HO, Hsinchu (TW); Aum Sagar PANDA, Hsinchu (TW); Yi-Chien LEE, Hsinchu (TW); Chen-Jung HUNG, Hsinchu (TW); Kang-Ping LIU, Hsinchu (TW); Cheng-Yen CHANG, Hsinchu (TW); Gkreti-Maria MANESI, Ioannina (GR); Apostolos AVGEROPOULOS, Ioannina (GR); Fan-Gang TSENG, Hsinchu (TW); Fu-Rong CHEN, Hsinchu (TW)

(21) Appl. No.: 18/361,018

(22) Filed: Jul. 28, 2023

(30) Foreign Application Priority Data
Jul. 3, 2023 (TW) 112124822

(51) Int. Cl. B29C 71/02; C08J 5/18

(52) U.S. Cl. CPC C08J 7/08; C08J 5/18; C08J 2383/10

(57) ABSTRACT

A method for reducing surface tension of polymer material by decompression effect includes step as follows. A decompression step is performed, wherein a polymer material is placed at a low pressure environment to reduce a surface tension of the polymer material, and a pressure of the low pressure environment is lower than 10⁵ Pa.

### RELATED APPLICATIONS

This application claims priority to Taiwan Application Serial Number 112124822, filed Jul. 3, 2023, which is herein incorporated by reference.

### BACKGROUND

### Technical Field

The present disclosure relates to a method for reducing surface tension of polymer material and a method for controlling orientation of block copolymer thin film. More particularly, the present disclosure relates to a method for reducing surface tension of polymer material by decompression effect and a method for controlling orientation of block copolymer thin film by decompression effect.

### Description of Related Art

The self-assembly of the block copolymer (BCP) has received intensive attention and research because of it can create a variety of well-ordered nanostructured phase. In the thin-film state, the microphase-separated nanostructures from the BCP self-assembly generate the well-defined nanopatterns which can be used in the soft lithography or other industrial applications.

At present, among various nanostructured phases, the perpendicularly oriented nanostructures are critical for the practical applications of the block copolymer thin film for nanopatterning. The silicon-based block copolymer is one of the most commonly used BCP, but it has the problem of block with extremely low surface energy, which results in the formation of a wetting layer on the air surface, so as to hinder the perpendicular orientation of the BCP thin film.

Therefore, how to solve the problem of the low surface energy of the polymer material to achieve the target controlled orientation of well-ordered nanostructure of BCP thin film effectively is the goal of the relevant industry.

### SUMMARY

According to one aspect of the present disclosure, a method for reducing surface tension of polymer material by decompression effect includes step as follows. A decompression step is performed, wherein a polymer material is placed at a low pressure environment to reduce a surface tension of the polymer material, and a pressure of the lower pressure environment is lower than 10⁵ Pa.

According to another aspect of the present disclosure, a method for controlling orientation of block copolymer thin film by decompression effect includes steps as follows. A block copolymer thin film is provided, wherein the block copolymer thin film includes a first block and a second block. A decompression step is performed, wherein the block copolymer thin film is placed at a low pressure environment to reduce a surface tension difference between the first block and the second block, so as to control an orientation of the block copolymer thin film, and a pressure of the lower pressure environment is lower than 10⁵ Pa.

### BRIEF DESCRIPTION OF THE DRAWINGS

The present disclosure can be more fully understood by reading the following detailed description of the embodiment, with reference made to the accompanying drawings as follows:

FIG. 1 is a flow chart of a method for reducing surface tension of polymer material by decompression effect according to one embodiment of the present disclosure.

FIG. 2 is a flow chart of a method for controlling orientation of block copolymer thin film by decompression effect according to another embodiment of the present disclosure.

FIG. 3 is a surface tension-pressure diagram of Example 1 to Example 6.

FIG. 4A is a scanning probe microscopy (SPM) phase image of Comparative Example 1.

FIG. 4B is a SPM phase image of Example 10.

FIG. 5A is a FE-SEM image of Comparative Example 1 after O₂ etching.

FIG. 5B is a FE-SEM image of Example 7 after O₂ etching.

FIG. 5C is a FE-SEM image of Example 8 after O₂ etching.

FIG. 5D is a FE-SEM image of Example 9 after O₂ etching.

FIG. 5E is a FE-SEM image of Example 10 after O₂ etching.

FIG. 6A is a FE-SEM image of Comparative Example 1 after CF₄/O₂ and O₂ etching.

FIG. 6B is a FE-SEM image of Example 7 after CF₄/O₂ and O₂ etching.

FIG. 6C is a FE-SEM image of Example 8 after CF₄/O₂ and O₂ etching.

FIG. 6D is a FE-SEM image of Example 9 after CF₄/O₂ and O₂ etching.

FIG. 6E is a FE-SEM image of Example 10 after CF₄/O₂ and O₂ etching.

### DETAILED DESCRIPTION

The present disclosure will be further exemplified by the following specific embodiments. However, the embodiments can be applied to various inventive concepts and can be embodied in various specific ranges. The specific embodiments are only for the purposes of description, and are not limited to these practical details thereof.

### <Method for Reducing Surface Tension of Polymer Material by Decompression Effect>

Reference is made to FIG. 1, which is a flow chart of a method for reducing surface tension of polymer material by decompression effect 100 according to one embodiment of the present disclosure. In FIG. 1, the method for reducing surface tension of polymer material by decompression effect 100 includes a step 110.

In the step 110, a decompression step is performed, wherein a polymer material is placed at a low pressure environment to reduce a surface tension of the polymer material, and a pressure of the low pressure environment is lower than 10⁵ Pa. Specifically, the surface tension variation of the polymer material is related to the density variation thereof, and the change of the density dependence on the environment conditions at which increasing the temperature or decreasing the pressure can both reduce the density of the polymer material. Thus, increasing the temperature or decreasing the pressure can also reduce the surface tension of the polymer material, but the polymer material may be thermally degraded due to the extremely high temperature. Therefore, the present disclosure uses the decompression method to reduce the surface tension of the polymer material at the mild temperature.

### <Method for Controlling Orientation of Block Copolymer Thin Film by Decompression Effect>

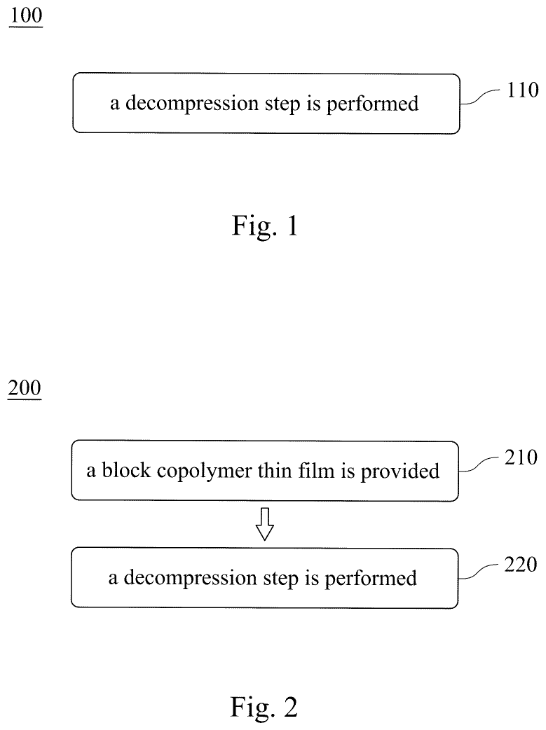

Reference is made to FIG. 2, which is a flow chart of a method for controlling orientation of block copolymer thin film by decompression effect 200 according to another embodiment of the present disclosure. In FIG. 2, the method for controlling orientation of block copolymer thin film by decompression effect 200 includes a step 210 and a step 220.

In the step 210, a block copolymer thin film is provided, wherein the block copolymer thin film includes a first block and a second block, and a surface tension of the first block can be greater than a surface tension of the second block. Specifically, if the surface tension difference between the two blocks in the block copolymer thin film is large, the second block with the lower surface tension will form a wetting layer at the interface between the air and the copolymer to hinder the controlled orientation of the block copolymer thin film. In order to solve the above problem, it is necessary to reduce the surface tension difference between the first block and the second block to avoid the formation of the wetting layer.

In the step 220, a decompression step is performed, wherein the block copolymer thin film is placed at a low pressure environment to reduce a surface tension difference between the first block and the second block, so as to control an orientation of the block copolymer thin film, and a pressure of the low pressure environment is lower than 10⁵ Pa, preferably, the pressure of the low pressure environment can be 10⁰ Pa to 10⁻⁴ Pa. Moreover, the step 220 further includes the block copolymer thin film placed at a heating temperature for thermal annealing, wherein the heating temperature can be 250° C. to 350° C.

In detail, the aimed orientation to be achieved by the block copolymer thin film of the present disclosure is a perpendicular orientation, so that the block copolymer thin film can preferably be selected but not limited to a cylindrical silicon-based block copolymer thin film, which can be but not limited to polystyrene-block-polydimethylsiloxane (PS-b-PDMS). Thus, the first block is polystyrene (PS), and the second block is polydimethylsiloxane (PDMS), but the surface energy of PDMS block is extremely low which will hinder the controlled orientation of the block copolymer thin film.

Therefore, the present disclosure reduces the surface tension difference between the first block and the second block by the influence of reducing pressure on the surface tension of the polymer material. When the pressure is reduced to the high vacuum, the surface tension between the block copolymer components can reach an equivalent value, that is, the surface tension of the first block can be reduced to close to the surface tension of the second block, so that the neutral surface can be formed at the interface between the air and the copolymer. Thus, the block copolymer thin film can form a plurality of perpendicularly oriented cylindrical structures which are ordered arrangement. This method does not require any complicated process to manufacture the neutral surface, such as a neutral layer coating, etc., can solve the general wetting layer problem of the silicon-based block copolymer, and can achieve the application of perpendicularly oriented nanostructure patterns.

The present disclosure will be further exemplified by the following specific embodiments so as to facilitate utilizing and practicing the present disclosure completely by the people skilled in the art without over-interpreting and over-experimenting. However, the readers should understand that the present disclosure should not be limited to these practical details thereof, that is, these practical details are used to describe how to implement the materials and methods of the present disclosure and are not necessary.

### Example/Comparative Example

### <Pressure Effect on Surface Tension of Polymer Material>

Example 1 to Example 6 of the present disclosure uses the capillary height method to measure the surface tension under the specific environmental conditions thereof. The type of polymer material and the environmental condition of Example 1 to Example 6 are shown in Table 1.

TABLE 1

| | Polymer material | Temperature (° C.) | Pressure (Pa) |
|---|---|---|---|
| Example 1 | PS | 180 | — |
| Example 2 | PS | 200 | — |
| Example 3 | PS | 220 | — |
| Example 4 | PDMS | 180 | — |
| Example 5 | PDMS | 200 | — |
| Example 6 | PDMS | 220 | — |

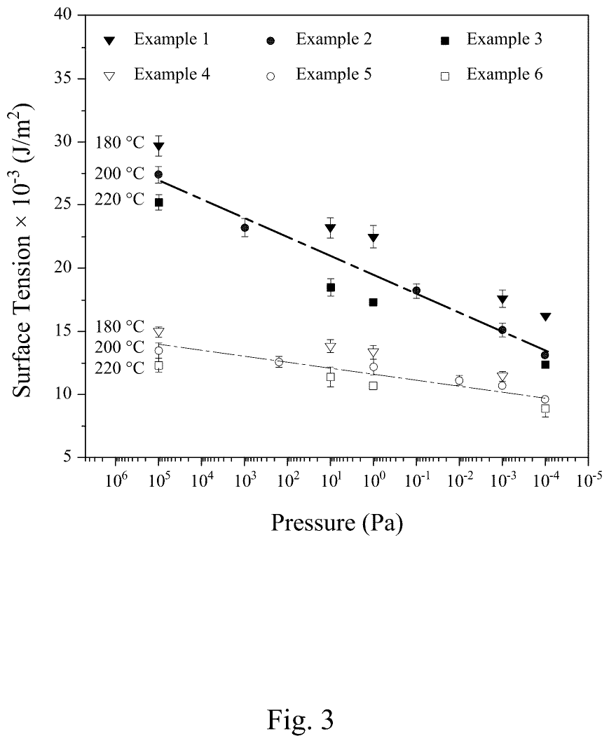

Reference is made to FIG. 3, which is a surface tension-pressure diagram of Example 1 to Example 6. As shown in FIG. 3, it can be seen that the surface tension of Example 1 to Example 6 decreases as the pressure decreases, and the surface tension of Example 1 to Example 3 decreases more significantly, indicating that the significant dependence of the surface tension on pressure for PS. Accordingly, as the pressure decreases to 10⁻⁴ Pa, the surface tension of PS can be reduced to be close to that of PDMS, so that the surface tension difference between PS and PDMS can be reduced by reducing the pressure at the mild temperature, and this result is beneficial for the subsequent controlling orientation of the block copolymer thin film.

### <Pressure Effect on Orientation of Block Copolymer Thin Film>

Example 7 to Example 10 and Comparative Example 1 of the present disclosure are the cylinder-forming PS₄₃-b-PDMS₁₇ block copolymers spin-coated on a silicon wafer to form the block copolymer thin film, and respectively under the pressure of 10⁰ Pa (Example 7), 10⁻¹ Pa (Example 8), 10⁻³ Pa (Example 9), 10⁻⁴ Pa (Example 10) and 10⁵ Pa (Comparative Example 1) with thermal annealing at 300° C. for 2 hours.

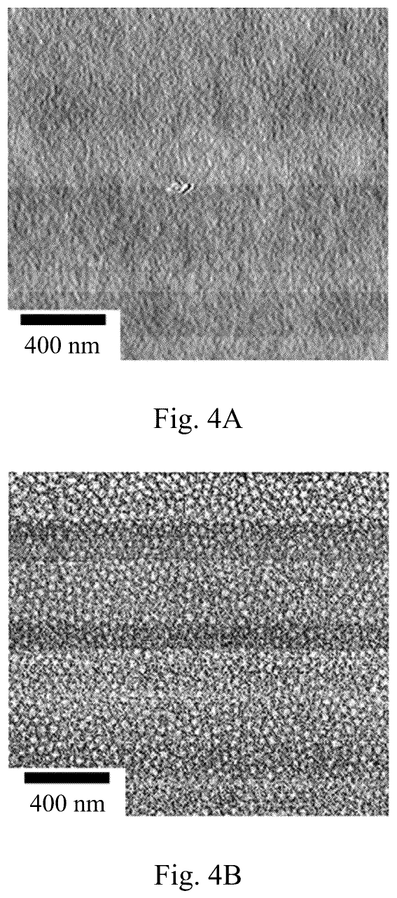

Reference is made to FIG. 4A and FIG. 4B, wherein FIG. 4A is a scanning probe microscopy (SPM) phase image of Comparative Example 1. FIG. 4B is a SPM phase image of Example 10. As shown in FIG. 4A and FIG. 4B, it can be seen that Comparative Example 1 under atmospheric pressure (10⁵ Pa), a flat featureless texture can be observed, which is due to the low surface tension of PDMS to form the wetting layer on the air surface to hinder the perpendicular orientation of the block copolymer thin film. In contrast, Example 10 under the high vacuum condition (10⁻⁴ Pa) gives the formation of a well-ordered texture with hexagonally packed lattice, indicating that when the pressure is reduced to the vacuum state, the surface tension difference between PS and PDMS is decreased, and the neutral surface is provided at the interface between the air and the copolymer, so that the block copolymer thin film forms the perpendicularly oriented cylindrical structures.

Then, in order to ensure the decompression effect orientation, Example 7 to Example 10 and Comparative Example 1 are treated with reactive ion etching (RIE) by using O₂ etchant for the degeneration of PS and conversion of PDMS into SiO₂ simultaneously to provide the surface texture image of the block copolymer thin film under field emission-scanning electron microscopy (FE-SEM).

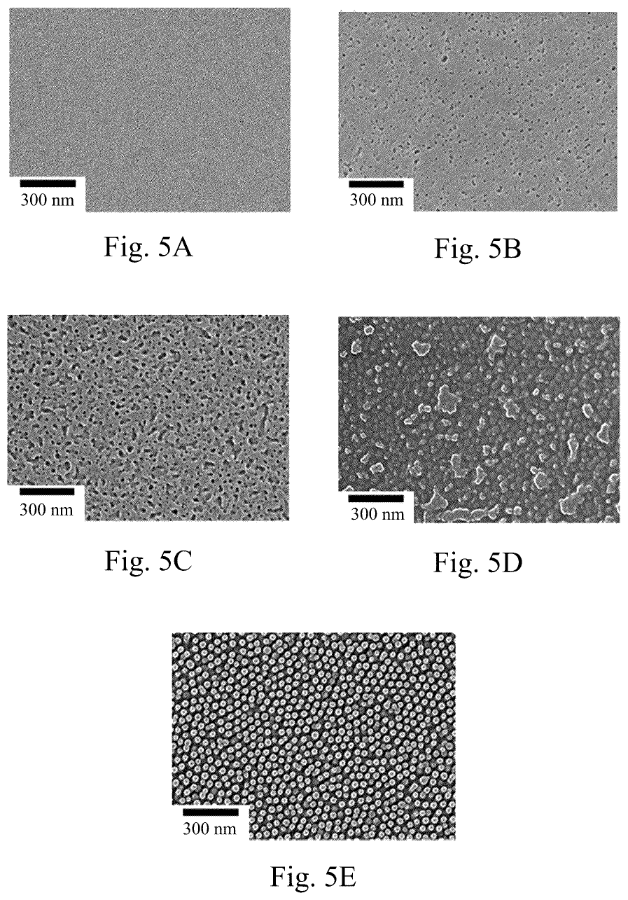

Reference is made to FIG. 5A, FIG. 5B, FIG. 5C, FIG. 5D and FIG. 5E, wherein FIG. 5A is a FE-SEM image of Comparative Example 1 after O₂ etching. FIG. 5B is a FE-SEM image of Example 7 after O₂ etching. FIG. 5C is a FE-SEM image of Example 8 after O₂ etching. FIG. 5D is a FE-SEM image of Example 9 after O₂ etching. FIG. 5E is a FE-SEM image of Example 10 after O₂ etching.

As shown in FIG. 5A to FIG. 5E, it can be seen that Comparative Example 1 under atmospheric pressure (10⁵ Pa), a flat surface can be observed, and its result is consistent with FIG. 4A. When the pressure is reduced to 10⁰ Pa, it can be observed that Example 7 has the random dotlike morphology, indicating that mostly PDMS wetting layer in Example 7, but the occasional present of PS component. Furthermore, when the pressure is reduced to 10⁻¹ Pa, it can be observed that Example 8 has the PS component etched by O₂ RIE; while at 10⁻³ Pa, it can be observed that the coverage of the PDMS wetting layer of Example 9 is significantly decreased, indicating that the problem of wetting layer formation due to the low surface tension of PDMS can be solved by decreasing the pressure. Finally, further reducing the pressure to the high vacuum (10⁻⁴ Pa), it can be observed that the entire surface of Example 10 has the dotlike morphology with hexagonally packed lattice structure, indicating that there is no wetting layer formation for the thermally annealed under the high vacuum condition due to the formation of the neutral surface of the block copolymer thin film.

Furthermore, in order to further examine the decompression effect orientation, Example 7 to Example 10 and Comparative Example 1 are treated with RIE by using CF₄/O₂ mixed gas to remove PDMS of the top layer, followed by RIE with O₂ etchant to provide the surface texture image of the block copolymer thin film under FE-SEM.

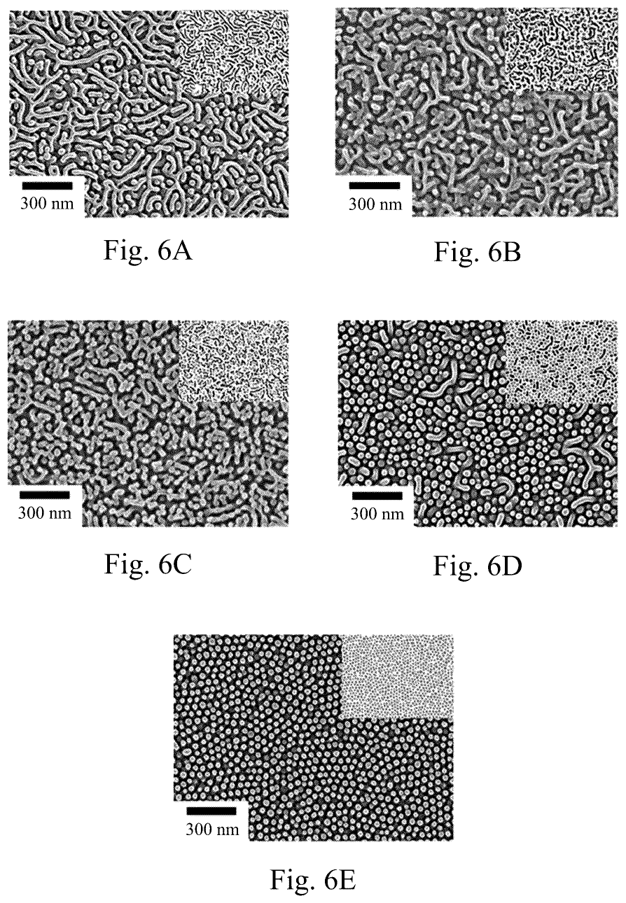

Reference is made to FIG. 6A, FIG. 6B, FIG. 6C, FIG. 6D and FIG. 6E, wherein FIG. 6A is a FE-SEM image of Comparative Example 1 after CF₄/O₂ and O₂ etching. FIG. 6B is a FE-SEM image of Example 7 after CF₄/O₂ and O₂ etching. FIG. 6C is a FE-SEM image of Example 8 after CF₄/O₂ and O₂ etching. FIG. 6D is a FE-SEM image of Example 9 after CF₄/O₂ and O₂ etching. FIG. 6E is a FE-SEM image of Example 10 after CF₄/O₂ and O₂ etching.

As shown in FIG. 6A to FIG. 6E, it can be seen that Comparative Example 1 under atmospheric pressure (10⁵ Pa), the randomly oriented texture with linelike and dotlike morphologies can be observed, and the ratio of linelike morphologies is greater than that of dotlike morphologies, indicating that due to PDMS will form the wetting layer on the air surface, the parallel oriented cylindrical structures will appear as the linelike morphologies. Furthermore, as the pressure decreases, the regions with dotlike morphologies gradually increase in Example 7 and Example 8, indicating that the decrease of pressure (increase of vacuum) results in the formation of perpendicularly oriented cylindrical structures; while the pressure is 10⁻³ Pa, the coverage of the dotlike morphologies in Example 9 is significantly increased, indicating that the problem of the low surface tension of PDMS can be greatly alleviated by reducing the pressure. Finally, when the pressure is reduced to the high vacuum (10⁻⁴ Pa), it can be observed that the large number of hexagonally packed dotlike morphologies in Example 10, indicating that the perpendicular orientation of the block copolymer thin film can be successfully driven by the vacuum effect during the thermal annealing due to the neutral surface formation.

In conclusion, the present disclosure reduces the surface tension difference between the components of the block copolymer thin film by the influence of reducing the pressure on the surface tension of the polymer material, so as to control the orientation of the block copolymer thin film. In addition, when the pressure is reduced to the high vacuum environment, the block copolymer thin film can form the perpendicularly oriented cylinder structures with the high ordered arrangement. Thus, the problem of forming the wetting layer by the silicon-based block copolymer can be solved by adjusting the environmental conditions without any additional complicated process, so as to facilitate the application of the block copolymer thin film in nanopatterns.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A method for reducing surface tension of polymer material by decompression effect, comprising:
performing a decompression step, wherein a polymer material is placed at a low pressure environment to reduce a surface tension of the polymer material, and a pressure of the low pressure environment is lower than 10⁵ Pa.

2. A method for controlling orientation of block copolymer thin film by decompression effect, comprising:
providing a block copolymer thin film, wherein the block copolymer thin film comprises a first block and a second block; and
performing a decompression step, wherein the block copolymer thin film is placed at a low pressure environment to reduce a surface tension difference between the first block and the second block, so as to control an orientation of the block copolymer thin film, and a pressure of the low pressure environment is lower than 10⁵ Pa.

3. The method for controlling orientation of block copolymer thin film by decompression effect of claim 2, wherein a surface tension of the first block is greater than a surface tension of the second block.

4. The method for controlling orientation of block copolymer thin film by decompression effect of claim 3, wherein the block copolymer thin film is a silicon-based block copolymer thin film.

5. The method for controlling orientation of block copolymer thin film by decompression effect of claim 4, wherein the first block is polystyrene, and the second block is polydimethylsiloxane.

6. The method for controlling orientation of block copolymer thin film by decompression effect of claim 2, wherein the pressure of the low pressure environment is 10⁰ Pa to 10⁻⁴ Pa.

7. The method for controlling orientation of block copolymer thin film by decompression effect of claim 2, wherein in the decompression step, further comprises the block copolymer thin film placed at a heating temperature for thermal annealing, and the heating temperature is 250° C. to 350° C.

8. The method for controlling orientation of block copolymer thin film by decompression effect of claim 2, wherein the orientation of the block copolymer thin film is a perpendicular orientation after the decompression step.

9. The method for controlling orientation of block copolymer thin film by decompression effect of claim 8, wherein the block copolymer thin film forms a plurality of perpendicularly oriented cylindrical structures after the decompression step.

10. The method for controlling orientation of block copolymer thin film by decompression effect of claim 9, wherein the perpendicularly oriented cylindrical structures are ordered arrangement.
